(19) United States
(12) Patent Application Publication
(10) Pub. No.: US 2006/0030440 A1
(43) Pub. Date: Feb. 9, 2006

(54) Bicycle chain guide assembly allowing use of multiple chainrings for indirect chain drives of suspension bicycles

(75) Inventor: Mark T. Zmurko, Canton, CT (US)

Correspondence Address: MARK T. ZMURKO, 25 BENTON STREET, WINSTED, CT, 06098, US

(73) Assignee: Mr. Mark T. Zmurko, Canton, CT (US)

(21) Appl. No.: 10/710,834

(22) Filed: Aug. 5, 2004

(51) Int. Cl. F16H 9/00; F16H 61/00

(52) U.S. Cl. 474/80; 474/101

(57) ABSTRACT

A lower chain guide assembly to allow the use of multiple chainrings and front derailleur systems on indirect-drive chain driven bicycles.

### DISCLOSURE OF INVENTION

This patent cross references U.S. Pat. No. 6,045,470 issued to Wilcox on Apr. 4, 2000 which depicts prior art related to indirect bicycle chain drives and shifting idler cogs. Prior art, such as indirect drives, idler cogs, shifting apparatus, and chain guides, that are related to the field of this invention but not directly referenced, include the following patents: U.S. Pat. No. 6,629,903 issued Oct. 7, 2003 to Kondo, U.S. Pat. No. 6,354,973 issued Mar. 12, 2002 to Barnett, U.S. Pat. No. 5,725,450 issued Mar. 10, 1998 to Huskey, and U.S. Pat. No. 5,688,200 issued Nov. 18, 1997 to White.

### TECHNICAL FIELD

The invention relates to multiple chainring drivetrains of rear suspension bicycles that utilize an idler pulley to alter the chain line.

### BACKGROUND ART

The use of multiple chainrings and a plurality of rear wheel drive sprockets for chain driven rear suspension bicycles is well known in prior art. Also well known in prior art are the attempts to minimize the interaction of pedaling forces and suspension movement. Commonly in prior art, an idler pulley, sprocket, or cog is placed vertically and possibly horizontally from the axis of rotation of the crank assembly, of which said crank assembly consists of pedals, cranks, and multiple chainrings. From this point on in the literature, said idler cog will be used interchangeably for idler sprocket or idler pulley. Said chain passes from said chainrings to said idler cog to said rear sprockets and creates an indirect chain drive such that the chain driving tension forces minimally influence the suspension as well as suspension movements minimally influencing chain tension and rider pedaling input. Such said indirect chain drive systems are typically utilized in long travel suspension bicycles but may be applied to any bicycle suspension system. Indirect chain drive systems typically only use one chainring to maintain a simple chainline between said chainrings and said rear sprockets of said rear wheel drive assembly. To utilize multiple said chainrings in conjunction with a plurality of said rear sprockets for an indirect chain drive system, a special shifting system must be employed.

U.S. Pat. No. 6,045,470 issued to Wilcox illustrates a cog shifting system capable of shifting said chain between said multiple chainrings for an indirect chain drive system utilizing a shifting idler cog. However, such a system has a limitation on the distance the shifting idler cog may be placed from the axis of aforementioned crank assembly due to two features of a chain driven system.

The first limitation arises from the fact that to properly shift said chain from one chainring to a different chainring, the movement of the shifting apparatus must be relatively close to said chainrings in order to sufficiently ‘push’ or ‘pull’ said chain to a different chainring—if the distance of the shifting apparatus is too far from said chainrings, the natural side flex of said chain will not fully transmit the lateral movement to the sections of said chain that are nearest said chainrings and hence said system will not properly shift from said chainring to said different chainring.

The second limitation which prevents said shifting idler cog from being placed too great a distance from the axis of rotation of the aforementioned crank assembly is that, long vertical displacements with little horizontal displacement towards the rear of the bicycle, of said shifting idler cog creates the requirement for a lower guide pulley to be positioned on the ‘return’ low-tension side of the chain to provide a sufficient length of chain ‘wrap’ about said chainring. Chain wrap length, about said chainrings, approximately equal to half a revolution of any drive engaged chainring, is sufficient to distribute drive loads properly over said wrapped length to prevent said chain from skipping. However, placing said lower guide pulley as aforementioned defeats the purpose of said shifting idler cog—this is due to problems that arise from backpedaling which will be further explained in the subsequent literature.

Attempts in prior art to utilize an aforementioned lower placed guide pulley as for indirect drive chain systems have brought about chain drive systems that are limited to a single chainring. Said systems are not limited to the distance an idler cog is placed from the axis of rotation. Said systems also provide sufficient chain wrap length to handle the drive loads and thus allow the proper use of said idler cog to accomplish the intended goal of minimizing suspension movement and drive force interaction. However, said single chainring systems provide bicycle drive systems with very limited gear ratios and are commonly only used for specialty bicycles with long travel rear suspensions that are intended to primarily function while pedaling downhill and gravity assisted.

There is a desire in the bicycle field to provide a system that utilizes a highly placed shifting idler cog in combination with a lower guide pulley, which is also capable of shifting a chain between multiple chainrings. The difficulty in creating such a system exists during back pedaling. Back pedaling is used by cyclists for many reasons. Back pedaling is commonly used to reposition a cyclists feet, start the pedals in a comfortable location, or to avoid foot or pedal impact with natural or manmade obstacles. A bicycle chain drive system must be able to back pedal efficiently with minimal drag or without causing chain derailment. Said lower guide pulley of said systems cannot move together with the aforementioned highly placed shifting idler cog since up shifting said chain will cause said chain to jam as it attempts to move entirely from a smaller diameter chainring to a larger diameter chainring in one motion—for proper chainring up shifting to occur, said chain must be guided by prior art shifting apparatus on the tension side of the drive chain in a position located slightly above said chainring and directly about the chainline between said chainring and said shifting idler cog, such that said chain properly ‘wraps’ and transfers from said smaller chainring to said larger chainring while the aforementioned crank assembly is rotating from rider input.

If a stationary lower guide pulley that possesses a wider groove is used on said systems, where the minimum width of said groove is equal to the total number of chainrings multiplied by the width of said chain, said system will allow proper forward pedaling; however, during back pedaling, the rear derailleur, known from prior art, will lead said chain to the lateral position of the aforementioned rear sprocket that said rear derailleur is positioned in and the altered chain line of the lower guide pulley. If said rear derailleur is positioned in a said rear sprocket that is in line with the selected said front chainring and thus having no lateral displacement, then back pedaling will function properly; however, if said rear derailleur is positioned in said rear sprocket that is laterally out of line with said front chainring, the chain will drift towards the lateral line of said rear sprocket and cause chain derailment from said chainring. Malfunction of such a drive system can be disastrous and possibly create injury when thus attempting forward drive pedaling after back pedaling.

Thus exists the need for a device that will properly allow forward and back pedaling, in any drive combination of chainrings and sprockets, for indirect chain drive systems that utilize a highly placed shifting idler cog on the tension side of the driving chain and a lower placed guide pulley on the ‘return’ low tension side of the driving chain.

### BRIEF DESCRIPTION OF THE DRAWINGS

FIG. 1 is a right rear isometric view of a two chainring drive system with the chain in the larger chainring.

FIG. 2 is a right side view of FIG. 1.

FIG. 3 is a left side view of FIG. 1.

FIG. 4 is a right rear isometric view of a two chainring drive system with the chain in the smaller chainring.

FIG. 5 is a left rear isometric view of a two chainring drive system omitting shifting apparatus and idler cog apparatus for clarity.

FIG. 6 is a top view representation of said invention chainlines.

### MODE FOR THE INVENTION

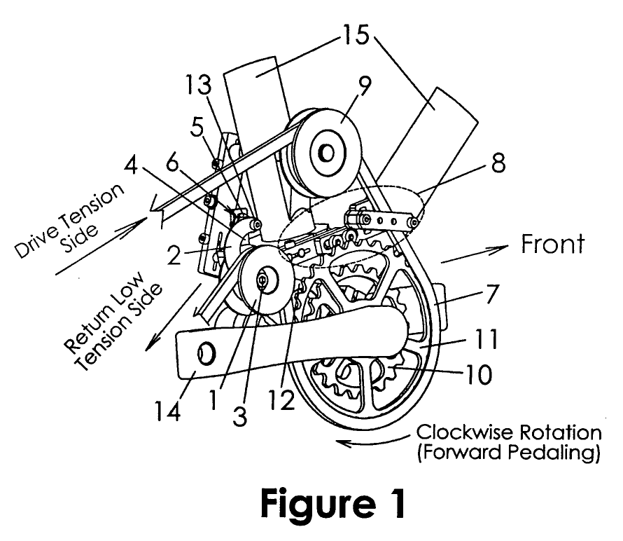

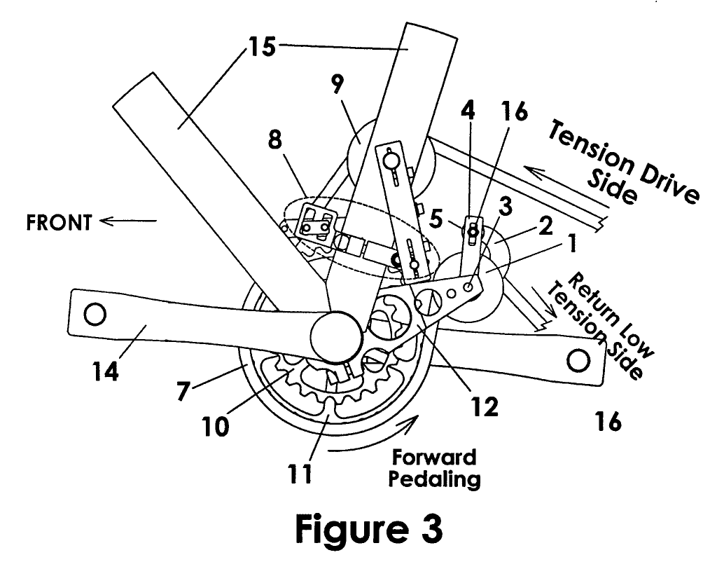

Shown in FIG. 1 is the shifting plate 2 positioned centrally in the groove of the lower guide pulley 1, and pivotally secured by bolt 13 to mounting adapter 4 about preload adjuster 5. The preload adjuster 5 contains a stepped down diameter smaller than the thru hole of the shifting plate 2 and wider than said shifting plate 2, such that the shifting plate 2 freely rotates about said preload adjuster 5. Omitted for clarity is a torsion spring which is fitted over preload adjuster 5 and secured by shifting plate 2. The first leg of said torsion spring engages slot 6 of the preload adjuster and the second leg of said torsion spring pushes against the back edge of the shifting plate 2 such that the torsion load pushes the bottom of the shifting plate 2 into the groove of the lower guide pulley 1. As aforementioned, the preload adjuster 5 is secured by bolt 13 through a vertical slot of mounting adapter 4 and a complimenting nut 16 (FIG. 3) on the backside of said mounting adapter 4 such that by rotating the preload adjuster 5 and securing with bolt 13, the slot of the preload adjuster 5 can be adjusted rotationally to adjust the torsion force of the not shown spring on the shifting plate 2. The adjustment of the torsion force allows fine tuning of the shifting plate to easily lift over the chain 7 during chainring shifting induced by shifting apparatus 8 and shifting idler pulley assembly 9, and to further return shifting plate 2 against lower guide pulley 1 upon shifting completion. The chain 7 is shown positioned on the larger chainring 11. The chain 7 is secured between the right side of the chain plate 2, and inside the groove of the lower guide pulley 2. The shifting apparatus 8 and shifting idler pulley assembly 9 are positioned directly above the larger chainring 10. It is not the scope of this invention to explain prior art shifting pulley and shifting apparatus. The scope of this invention is to enhance such indirect drive systems to allow the use of multiple chainrings 10, 11 on said systems.

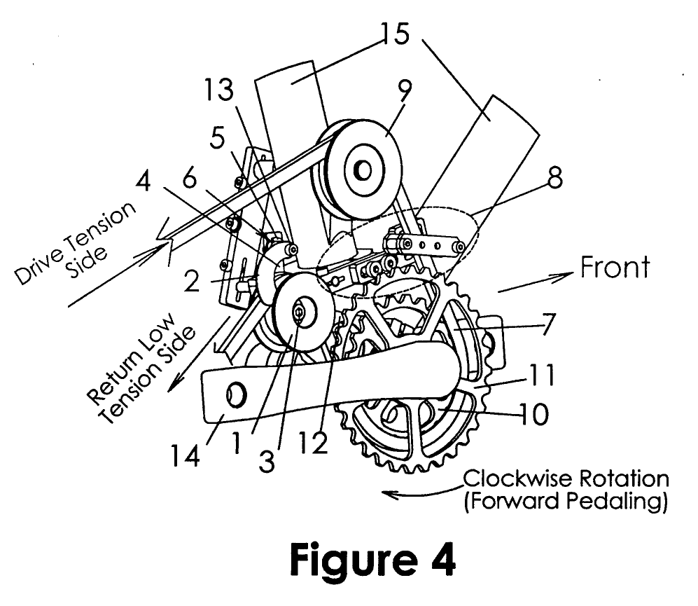

FIG. 4 depicts the chain 7 in the smaller chainring 10 position. The shifting apparatus 8 and shifting idler pulley assembly 9 are positioned directly over the smaller chainring 10. The chain 7 is shown on the left side of the shifting plate 2 and retained by the inner groove flange of the lower guide pulley 1.

Shown in FIG. 3 is the mounting bracket 12 that secures to the bicycle frame 15. The mounting bracket is clamped to the frame such that it can rotate about the aforementioned crank assembly axis to optimally place the lower guide pulley 2 to vary the length of chainwrap in order to accommodate a variety of shifting idler pulley 9 positions and provide a chainwrap of approximately half a revolution. The mounting adapter 4 is secured between the lower guide pulley 1 and the mounting bracket 12 and by bolt 3 of FIG. 1 and said mounting adapter can thus be positioned anywhere radial about the axis of bolt 3 of FIG. 1. The adjustable radial position of the mounting adapter 4 allows the shifting plate 2 to be optimally tuned to readily lift over chain 7 during shifting.

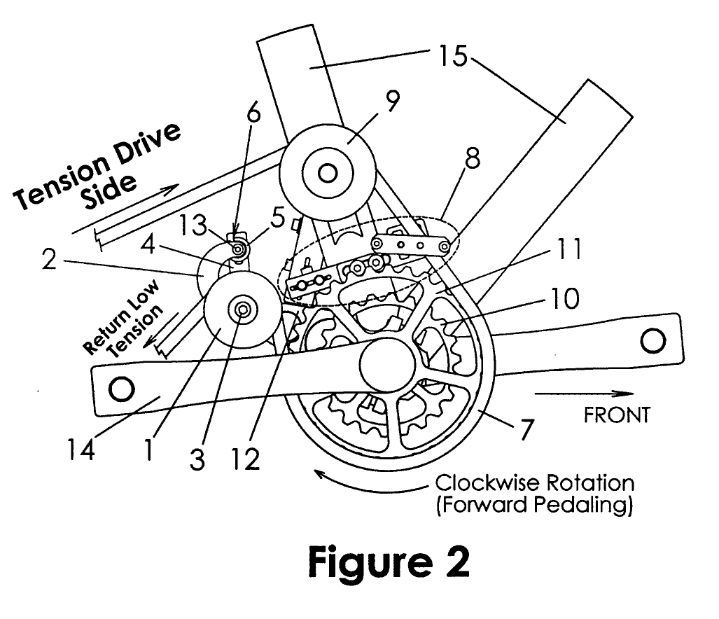

During up chainring shifting, the chain 7 is guided by the movement of shifting apparatus 8 and shifting idler pulley 9 from chainring 10 to chainring 11 at the chain location nearest the shifting apparatus 8. As the crank assembly 14 rotates due to the cyclist input, the chain 7 transfers in a clockwise manner viewed in FIG. 1 from the smaller chainring 10 to the larger chainring 11. After the chain is fully engaged on the larger chainring 11, the chain pushes against the inside of the shifting plate 2 and the sides of the chain links of the chain 7 lift and rotate the shifting plate 2 clockwise (FIG. 2) against the torsion force of the spring (not shown for clarity) about the preload adjuster 5. The chain 7 then passes under the shifting plate 2, and after fully passing by the shifting plate 2, the torsion force pushes the shifting plate 2 back against the lower guide pulley 2 groove.

During down chainring shifting, the cyclist rotates the crank assembly clockwise (FIG. 2) and the opposite as up shifting occurs as the chain 7 moves, led by the movement of shifting apparatus 8 and shifting idler pulley 9, from chainring 11 to chainring 10 at the chain location nearest the shifting apparatus 8. The chain 7 drops from the larger chainring 11 to the smaller chainring 10 and after full transfer to chainring 10, the chain links press against the outside of shifting plate 2 and thus lift the shifting plate 2 and pass under. After the chain 7 passes under the shifting plate 2, the torsion load rotates the shifting plate 2 back against the lower guide pulley 1.

While back pedaling in any combination of chainrings 10,11 and aforementioned rear sprockets, the chain 7 runs against the shifting plate 2 and attempts to rotate the shifting plate 2 counterclockwise (FIG. 2) into the lower guide pulley 1. The shifting plate 2 cannot rotate counterclockwise since it is pressed against the lower guide pulley 1 and thus the chain 7 remains in the same position and prevents the chain from derailing.

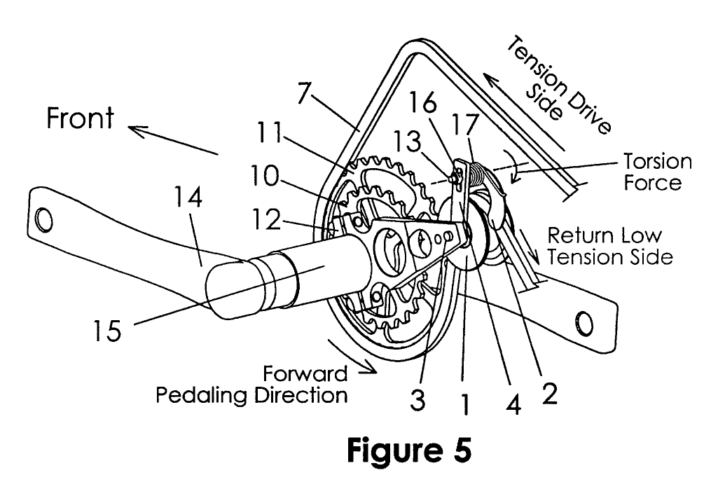

FIG. 5 depicts said invention from a left rear isometric view, omitting aforementioned shifting apparatus and shifting idler cog for clarity. Spring 17 is depicted to indicate direction of torsion force created and acted upon shifting plate 2. Chain 7 is depicted about larger chainring 11 and about lower guide pulley 1, retained between lower guide pulley 1 flange and shifting plate 2. Lower guide pulley 1 is mounted rotationally by bolt 3 to mounting bracket 12 which is clamped to and rotationally adjustable to frame member 15 to adjust aforementioned length of chainwrap. Mounting bracket 12 is also laterally adjustable to frame member 15 to laterally align the lower guide pulley 1 to smaller chainring 10 and larger chainring 11.

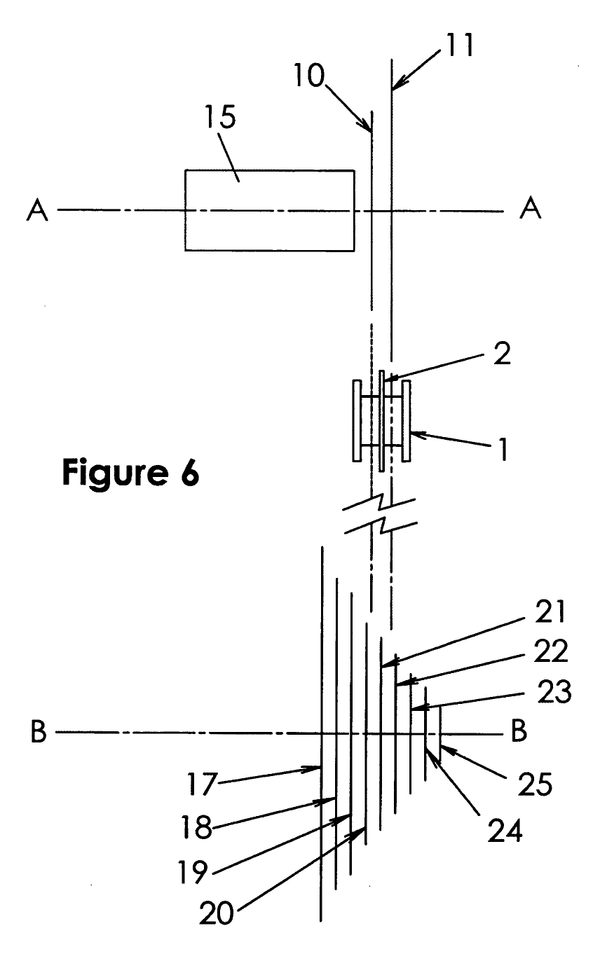

FIG. 6 depicts a representation of the aforementioned chain drive system and illustrates the retention of chain 7 (not shown) in various gear combinations of said drive system. If said chain 7 (not shown) is positioned about smaller chainring 10 by forward rotation of aforementioned crank assembly about axis A-A, said chain 7 (not shown) self aligns between left flange of lower guide pulley 1 and inner face of shifting plate 2. Should drive assembly be back pedaled while the commonly known and aforementioned rear derailleur positions said chain 7 (not shown) in rear drive cogs 17, 18, 19, 20, 21, 22, 23, 24, 25, said shifting plate 2 retains said chain 7 (not shown) in proper alignment with said smaller chainring 10. Without said invention, said chain 7 would derail to the left during back pedaling from smaller chainring 10 while said chain 7 (not shown) is positioned in rear cogs that are laterally displaced to the left of the chain line of said smaller chainring 10, such as rear cogs 17, 18, 19, and 20 due to the fact that the rear cogs lead the chain during back pedaling for a chain drive system with a lower guide pulley. If said chain 7 (not shown) is positioned about smaller chainring 10 and is backpedaled while in said rear cogs laterally displaced to the left of said smaller ring 10 chainline, said chain 7, will tend to derail from said smaller chainring 10 into larger chainring 11 and cause chain skipping. If said chain 7 (not shown) is located in larger chainring 11, said chain 7 (not shown) is retained in proper alignment by shifting plate 2 and the right side flange of said lower guide pulley 1. Without said invention, said chain 7 would derail from larger chainring 11 to smaller chainring 10 while said chain 7 is positioned in rear cogs laterally positioned to the left of the chainline of said larger chainring 11, such as rear cogs 17, 18, 19, 20, and 21; and said chain 7 would derail externally to the right of said larger chainring 11, if said chain 7 (not shown) is located in rear cogs positioned laterally to the right of the chainline of said larger chainring 11, such as rear cogs 22, 23, 24 and 25.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

In accordance with my invention, I claim:

1. A chain guide assembly mounted on the return side of the chain of a chain driven suspension bicycle, of which said chain guide assembly consists of:
a mounting bracket attached to a bicycle frame by means of clamping to said bicycle frame,
a lower guide pulley, with a groove and flanges, mounted rotationally to said mounting bracket, and positioned to support said chain on the return low tension side of the drive chain,
an adapter plate mounted to said mounting bracket,
a preload adjuster mounted to said adapter plate,
a chain plate mounted pivotally to said preload adjuster, and held against said lower guide pulley by means of,
a torsion spring positioned about said preload adjuster, and held in place by said chain plate, wherein one side of said torsion spring engages said preload adjuster and opposite side of said torsion spring engages said chain plate.

2. A chain guide assembly as cited in claim 1, wherein said mounting bracket is bolted to said bicycle frame.

3. A chain guide assembly as cited in claim 1, wherein said mounting bracket is welded or bonded to said bicycle frame.
